(19) United States
(12) Patent Application Publication
(10) Pub. No.: US 2011/0213107 A1
(43) Pub. Date: Sep. 1, 2011

(54) Activation of monocyclopentadienyl group 6 complexes

(76) Inventors: Sandor Nagy, Naperville, IL (US); Linda N. Winslow, Cincinnati, OH (US); Karen L. Neal-Hawkins, Cincinnati, OH (US); Shahram Mihan, Bad Soden (DE); Lenka Lukesova, Frankfurt (DE)

(21) Appl. No.: 12/660,555

(22) Filed: Mar. 1, 2010

(51) Int. Cl. C08F 4/42; B01J 31/22

(52) U.S. Cl. 526/126; 502/118

(57) ABSTRACT

A method for preparing a supported catalyst suitable for use in slurry and gas-phase olefin polymerizations is disclosed. An alumoxane-treated silica is combined with a monocyclopentadienyl Group 6 metal complex that comprises a chelating Cp moiety to give the supported catalyst. The method is simple to practice and provides catalysts having high activity. Polyolefins made using the catalysts have high molecular weight that is readily controlled by adding hydrogen.

### FIELD OF THE INVENTION

The invention relates to catalysts useful for polymerizing olefins, and in particular, to an improved way to activate monocyclopentadienyl Group 6 metal complexes.

### BACKGROUND OF THE INVENTION

The original olefin polymerization catalysts based on Group 6 metals are typically chromium oxides immobilized on inorganic oxide supports. These catalysts are mainstays of the industry for producing high-molecular-weight polyolefins. It became desirable, however, to find other catalysts that allow manufacturers better control over polymer molecular weight through hydrogen addition. Thus, newer Group 6 metal-based “single-site” catalysts have been developed that allow such greater control. One class of these single-site complexes is known as monocyclopentadienyl or “monoCp” complexes.

MonoCp complexes of Group 6 metals, especially chromium, are now well known (see, e.g., U.S. Pat. Nos. 6,437,161 and 6,919,412 and references cited therein). The complexes frequently employ a cyclopentadienyl moiety (e.g., cyclopentadienyl, indenyl, fluorenyl, etc.) that coordinates with the Group 6 metal and is linked to an electron donor group capable of chelating with the metal. Thus, these are not metallocenes (because there is only one Cp-like group to coordinate with the metal) but rather a distinct class of non-metallocene, single-site complexes. MonoCp complexes generally provide good productivity, particularly when they are activated with alumoxanes and used for a solution polymerization (see U.S. Pat. No. 6,919,412, examples 11-63).

For many commercial olefin polymerization processes, including most gas and slurry-phase processes, a catalyst needs to be supported. Supporting and activating single-site complexes, particularly monoCp complexes, is often more challenging than one might suppose. Ordinary approaches tend to give polymers with very high molecular weights that are not easily controlled. Additionally, catalyst activity is often sacrificed when the complex is supported.

Procedures for supporting monoCp complexes have been described to a limited degree. Usually, the chromium complex, or its mixture with another organometallic complex, is combined with methylalumoxane, and this mixture is applied to the support either with a minimum amount of solvent (“incipient wetness” approach) or with a larger proportion of solvent to form a suspension, from which the solvent is later removed. See, e.g., U.S. Pat. No. 6,919,412, examples 65-81. In these procedures, the complex sees the alumoxane before the alumoxane interacts with the support.

In short, improved ways to support and activate monoCp Group 6 complexes are needed. Ideally, the way of supporting and activating the complex would provide catalysts with high activity and polymers with high molecular weight that is controllable by addition of hydrogen.

### SUMMARY OF THE INVENTION

The invention is a method for preparing a supported catalyst that is suitable for use in slurry and gas-phase olefin polymerizations. The method comprises combining an alumoxane-treated silica with a monocyclopentadienyl Group 6 metal complex, wherein the complex comprises a chelating Cp moiety, to give the supported catalyst. The method is simple to practice and provides catalysts having high activity. Polyolefins made using the catalysts have high molecular weight that is readily controlled by adding hydrogen.

### DETAILED DESCRIPTION OF THE INVENTION

Supported catalysts of the invention are prepared by combining a monocyclopentadienyl Group 6 metal complex with an alumoxane-treated silica.

Silicas suitable for use are readily available, and many are sold commercially. The silicas preferably have a surface area in the range of 10 to 1000 m²/g, more preferably from 50 to 800 m²/g, and most preferably from 200 to 700 m²/g. Preferably, the pore volume of the silica is in the range of 0.05 to 4.0 mL/g, more preferably from 0.08 to 3.5 mL/g, and most preferably from 0.1 to 3.0 mL/g. Preferably, the average particle size of the silica is in the range of 1 to 500 microns, more preferably from 2 to 200 microns, and most preferably from 2 to 50 microns. The average pore diameter is typically in the range of 5 to 1000 angstroms, preferably 10 to 500 angstroms, and most preferably 20 to 350 angstroms. Granular silicas are particularly preferred. Examples of suitable silicas include Davison 948 silica (product of GraceDavison) and Silysia G-3 silica (product of Fuji).

The silica may be treated thermally, chemically, or both prior to use by methods well known in the art to reduce the concentration of surface hydroxyl groups. Thermal treatment consists of heating (or “calcining”) the support in a dry atmosphere at elevated temperature, preferably greater than 100° C., and more preferably from 150 to 800° C., prior to use. A variety of different chemical treatments can be used, including reaction with organo-aluminum, -magnesium, -silicon, or -boron compounds. See, for example, the techniques described in U.S. Pat. No. 6,211,311, the teachings of which are incorporated herein by reference.

Prior to its combination with the Group 6 metal complex, the silica is treated with an alumoxane. Suitable alumoxanes are also well known, and many are commercially available as solutions in hydrocarbon solvents from Albemarle, AkzoNobel, and other suppliers. Examples include methylalumoxane, ethylalumoxane, isobutylalumoxane, and the like. Methylalumoxanes, such as MAO, modified methylalumoxane (MMAO), or polymethylalumoxane (PMAO) are particularly preferred.

The amount of alumoxane used is normally adjusted to provide a particular molar ratio of aluminum to Group 6 metal (M) in the supported catalyst. Preferably, this Al/M ratio is in the range of 2:1 to 10, 000:1, more preferably from 10:1 to 1,000:1, and most preferably from 50:1 to 500:1.

The manner of combining the silica and alumoxane is not critical. In one convenient method, the alumoxane is added to a suspension of the silica in a dry hydrocarbon, such as toluene, hexanes, or the like. The resulting slurry is also preferably heated to a temperature within the range of 40° C. to 130° C., more preferably from 65° C. to 100° C., and most preferably from 70° C. to 90° C. to ensure complete reaction of the silica with the alumoxane.

Conventional approaches to supporting monocyclopentadienyl Group 6 metal complexes on silica normally do not pre-react the silica and the alumoxane, although this is an important aspect of the inventive method. (See, e.g., U.S. Pat. Nos. 6,919,412 and 6,437,161, where the complex and MAO are premixed and then combined with silica.) As the examples below demonstrate, using an alumoxane-treated silica enables the preparation of supported monocyclopentadienyl Group 6 metal complexes having high activity and potential for making high molecular weight polyolefins.

The alumoxane-treated silica is combined with a monocyclopentadienyl Group 6 metal complex to give the supported catalyst. The complex contains a Group 6 metal, i.e., chromium, molybdenum, or tungsten. Chromium is particularly preferred.

The complex includes a “chelating Cp moiety.” The chelating Cp moiety is a monocyclopentadienyl group that is linked to an electron donor such that the pair can coordinate as a bidentate ligand to the metal. The monocyclopenta-dienyl group, which coordinates to the metal using π-electrons of a cyclopentadienyl ring in so-called “η⁵ coordination,” can be a substituted or unsubstituted cyclopentadienyl, indenyl, fluorenyl, tetrahydroindenyl, dihydroindacenyl, or heterocycle-fused cyclopentadienyl group, or the like. Indenyl groups are particularly preferred. It is convenient to link the monocyclopentadienyl group to the electron donor using a divalent carbon or silicon-containing bridge, such as methylene, ethylene, isopropylene, dimethylsilylene, diphenylmethylene, or the like. The electron donor bonds to or interacts with the metal to achieve a chelate effect. This is accomplished with amine, ether, thioether, or phosphine functionality. Preferably, the N, O, S, or P is part of a substituted or unsubstituted heterocyclic group. Examples include 2-furyl, 2-pyridyl, 2-thienyl, 2-pyrrolyl, 2-indolyl, 2-quinolinyl, 8-quinolinyl, or the like. Other suitable monocyclopentadienyl groups, divalent linking groups, and electron donor groups are described in the references listed immediately below.

Many suitable monocyclopentadienyl Group 6 complexes are known. For examples, see U.S. Pat. Nos. 6,437,161; 6,919,412; 7,202,373; 7,507,782; 7,541,473; 7,541,481; and 7,619,090; and U.S. Pat. Appl. Publ. No. 2008/0269445, the teachings of which are incorporated herein by reference. For additional examples of suitable monocyclopentadienyl Group 6 complexes, see A. Döhring et al., Orqanometallics 19 (2000) 388 and references cited therein.

A few examples of suitable monocyclopentadienyl Group 6 metal complexes:

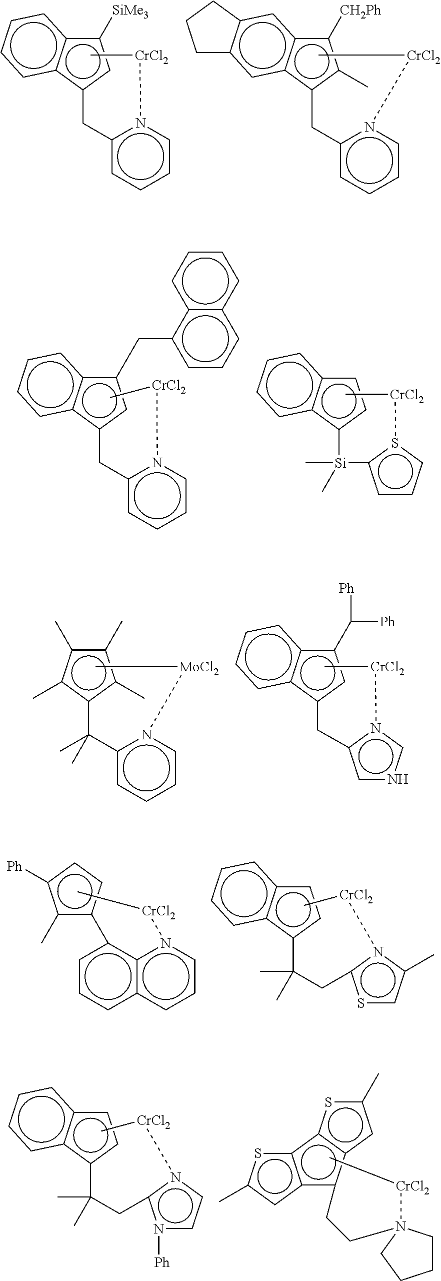

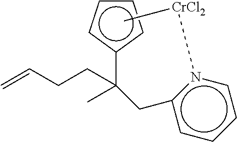

Preferred complexes incorporate a 2-pyridyl group. Particularly preferred complexes of this type have the structure:

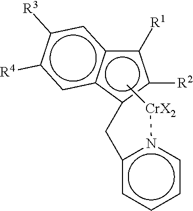

in which X is halide or C₁-C₅ alkyl, R¹ is C₇-C₂₀ aralkyl or trialkylsilyl, R² is H or C₁-C₅ alkyl, and each of R³ and R⁴ is hydrogen or are joined to form a C₅-C₆ cycloalkyl ring. In one preferred example, R³ and R⁴ are hydrogen, R¹ is trimethylsilyl, R² is hydrogen, and X is Cl. In another preferred example, R³ and R⁴ are joined to form a five-membered, saturated ring, R¹ is benzyl, R² is methyl, and X is Cl. In yet another preferred example, R³ and R⁴ are hydrogen, R¹ is (1-naphthyl)methyl, R² is hydrogen, and X is Cl.

The manner in which the alumoxane-treated silica and monocyclopentadienyl Group 6 metal complex are combined to give the supported catalyst is not critical. In one convenient method, a solution containing the complex is added to a slurry of the alumoxane-treated silica in a is hydrocarbon, and the mixture is stirred. The resulting catalyst is normally isolated by filtration and washed with additional hydrocarbon solvent prior to its use as an olefin polymerization catalyst.

In a preferred aspect of the inventive method, the monocyclopentadienyl Group 6 metal complex is combined with a boron compound having Lewis acidity prior to its combination with the alumoxane-treated silica. When a boron compound is included, the catalyst has very high molecular weight potential (see Example 3, below) that can be controlled with addition of hydrogen (see Examples 4 and 5).

Suitable boron compounds are Lewis acids, particularly compounds having one or more electron-withdrawing groups attached. Examples include ionic borates, boranes, borinic acids, boronic acids, and the like, and mixtures thereof. Perfluorinated organoboron compounds are preferred. Specific examples include lithium tetrakis(pentafluorophenyl)borate, sodium tetrakis(pentafluorophenyl)borate, anilinium tetrakis(pentafluorophenyl)borate, trityl tetrakis(pentafluorophenyl)borate (“F20”), tris(pentafluorophenyl)borane (“F15”), triphenylborane, tri-n-octylborane, bis(pentafluorophenyl)borinic acid, pentafluorophenylboronic acid, and the like. Other suitable boron compounds are described in U.S. Pat. Nos. 5,153,157, 5,198,401, and 5,241,025, the teachings of which are incorporated herein by reference.

The amount of boron compound needed depends upon the nature of the boron compound, Group 6 metal complex, and alumoxane used, solvents, reaction conditions, and other factors. Preferably, the alumoxane and boron compound are used in amounts that provide an aluminum to boron (Al/B) molar ratio within the range of 2 to 1000, more preferably from 10 to 500, most preferably from 50 to 250.

The inventive method requires that the silica be exposed to the alumoxane before the complex contacts the silica. This contrasts with earlier methods used to support monocyclopentadienyl Group 6 metal complexes. In one common earlier approach (illustrated by U.S. Pat. No. 6,919,412, Examples 65-81), solutions of the Group 6 metal complex and methylalumoxane are combined first. This mixture is then combined with silica to give a suspension, and the supported catalyst is isolated by filtration, washing, and drying. In another commonly practiced approach, the mixture of complex and MAO is added using a minimum amount of solvent to silica in a “pore filling” or “incipient wetness” technique in which the supported catalyst remains free-flowing throughout the addition of complex/activator mixture to the silica. This approach is illustrated below in Comparative Methods A1 and A3.

We surprisingly found that the inventive method provides silica-supported monocyclopentadienyl Group 6 metal complexes having improved activity. See Table 1, particularly Example 1 versus Comparative Examples 6 and 7, and Example 2 versus Comparative Example 8. There was simply no way to predict, a priori, the large activity increase resulting from using the inventive method of making a supported complex.

Polyolefins made using the catalysts have high molecular weight that is readily controlled by adding hydrogen. The weight-average molecular weight (Mw) values within the range of 10⁵ to 10⁷ illustrate the high molecular weight potential of catalysts made by the method. The ability to achieve high molecular weight and to control Mw with addition of hydrogen is further illustrated, particularly in Examples 3-5, in which an ionic borate (F20) is included in the catalyst.

Additional polymerizations (Examples 17-21, below) using Silysia G-3 silica from Fuji (Table 2) confirm that good activities and high Mw values can also be achieved with other granular silicas having a smaller particle size and higher surface area. These results further indicate that including a boron compound can facilitate production of polyolefins having narrower molecular weight distributions (compare Examples 17-19 and Examples 20-22).

The invention includes catalysts made by the method and their use to polymerize one or more olefins. Preferred olefins are ethylene, propylene, and C₄-C₂₀ α-olefins such as 1-butene, 1-hexene, 1-octene, and the like. Ethylene or mixtures of ethylene with propylene or a C₄-C₁₀ α-olefin are particularly preferred. Most preferred are polymerizations of ethylene with 1-butene, 1-hexene, 1-octene, and mixtures thereof.

Many types of olefin polymerization processes can be used. The supported catalysts are most beneficial for a slurry or gas-phase polymerization. The polymerizations can be performed over a wide temperature range, such as −30° C. to 280° C. A more preferred range is from 30° C. to 180° C.; most preferred is the range from 60° C. to 100° C. Olefin partial pressures normally range from 15 psig to 50,000 psig. More preferred is the range from 15 psig to 1000 psig.

The following examples merely illustrate the invention. Those skilled in the art will recognize many variations that are within the spirit of the invention and scope of the claims.

### Preparation of Complexes

### Example A

### Preparation of Chromium Complex 1

### (a) 1-(2-Pyridinylmethyl)-1-indanol

1-(2-Pyridinylmethyl)-1-indanol is generally prepared by the method of O. F. Beumel, Jr. et al., Synth. Commun. (1974) 43.

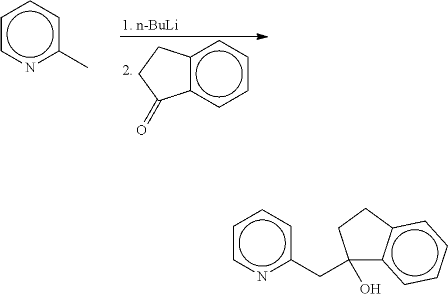

α-Picoline (29.5 mL, 0.3 mol) and tetrahydrofuran (140 mL) are placed in a 1-L flask. This solution is cooled to −20° C. and 15% n-butyllithium in hexane (187.5 mL, 0.3 mol) is added over 45 min. with stirring. The cooling is removed and the solution stirs for 1 h while the temperature rises to ambient. The resulting mixture is treated with a solution of 1-indanone (39.6 g, 0.3 mol) in tetrahydrofuran (35 mL) within 25 min. with vigorous stirring, while the temperature is maintained at 25° C. with slight cooling. The yellow solution is stirred for an additional 1.5 h and is then hydrolyzed with 15% aq. HCl (600 mL). The organic layer is isolated and removed. The water phase is washed once with Et₂O, then neutralized with aqueous ammonia solution and extracted with CHCl₃ (3×150 mL). The extracts are evaporated to give 1-(2-pyridinylmethyl)-1-indanol as a brown oil, which is used “as is” in the next step. Yield: 59.3 g (88%).

¹H NMR (CDCl₃): 8.60 (dm, 1H); 7.65 (td, 1H); 7.3-7.0 (m, 6H); 6.79 (br. s., 1H); 3.30 (d, 1H); 3.14 (d, 1H); 3.06 (ddd, 1H); 2.89 (dt, 1H); 2.35-2.20 (m, 2H).

### (b) 2-(1H-inden-3-ylmethyl)pyridine

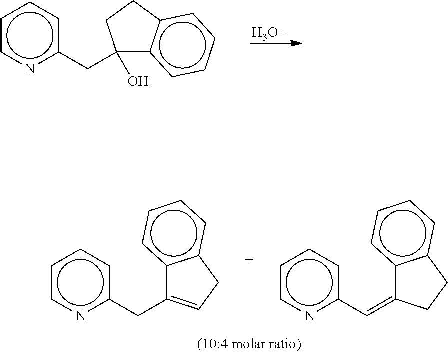

A solution of 1-(2-pyridinylmethyl)-1-indanol (59.3 g) in 10% aq. HCl (500 mL) is heated on a water bath for 3 h. Then the reaction mixture is extracted with Et₂O. The aqueous portion is isolated, neutralized with aqueous ammonia solution, and extracted with CHCl₃ (3×150 mL). The chloroform extracts are combined and dried over MgSO₄ and evaporated to give 52.7 g (95%) of a mixture of 2-(1H-inden-3-ylmethyl)pyridine and 2-[(E)-2,3-dihydro-1H-inden-1-ylidenemethyl]pyridine in a 10:4 molar ratio (by proton NMR) as a brown oil, which is used in the next stage without separation.

¹H NMR (CDCl₃): 2-(1H-inden-3-ylmethyl)pyridine: 8.61 (d, 1H); 7.61 (td, 1H); 7.51 (d, 1H); 7.36 (d, 1H); 7.32-7.22 (m, 3H); 7.16 (dd, 1H); 6.31 (m, 1H); 4.17 (br. s, 2H); 3.43 (br. s, 2H).

2-[(E)-2,3-dihydro-1H-inden-1-ylidenemethyl]pyridine: 8.68 (d, 1H); 7.65-7.09 (m, 8H); 3.30 (d, 1H); 3.34 (m, 2H); 3.16 (m, 2H).

### (c) 2-{[1-(trimethylsilyl)-1H-inden-3-yl]methyl}pyridine

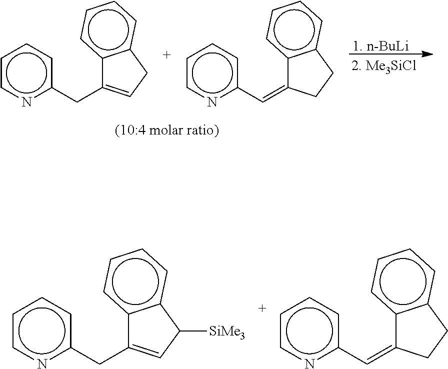

The mixture of isomers (38.1 g) is dissolved in Et₂O (380 mL) and the resulting solution is cooled to −90° C. n-Butyllithium (82 mL of 15% solution in hexane, 0.13 mol) is added over 30 min. with stirring. The resulting mixture stirs at −90° C. for an additional 1 h and is then allowed to warm to room temperature. The mixture is cooled again to −90° C. and is treated with a solution of Me₃SiCl (20 mL, 0.158 mol) in Et₂O (20 mL). The resulting mixture is allowed to warm to room temperature and is then stirred overnight.

The mixture is quenched with water and aqueous NH₄Cl solution. The organic phase is separated, washed with brine, and dried with MgSO₄. The solvent is removed to give 47.1 g (33%) of a mixture of 2-{[1-(trimethylsilyl)-1H-inden-3-yl]methyl}pyridine and 2-[2,3-dihydro-1H-inden-1-ylidenemethyl]-pyridine as a dark brown oil, which is used in the next stage without separation.

¹H NMR (CDCl₃): 2-{[1-(trimethylsilyl)-1H-inden-3-yl]methyl}pyridine: 8.59 (d, 1H); 7.57 (t, 1H); 7.48-7.10 (m, 6H); 6.46 (br. s, 1H); 4.23 (br. s, 2H); 3.50 (br. s, 1H); −0.01 (s, 9H).

(d) Chromium Complex 1

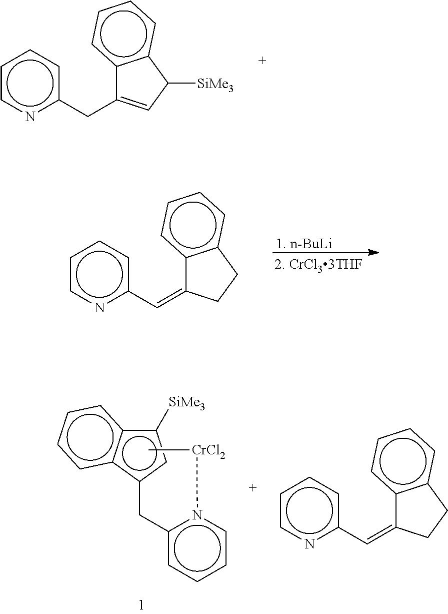

The mixture prepared in the previous step (47.1 g) is dissolved in tetrahydrofuran (400 mL). The resulting solution is cooled to −100° C. and is then treated with n-butyllithium (80 mL of 15% solution in hexane, 0.128 mol) over 45 min. with stirring. The mixture stirs at −100° C. for an additional 1 h. The resulting dark-red solution is allowed to warm to room temperature over about 2 h. The solution is then cooled again to −60° C. and is treated with CrCl₃.3THF (47 g, 0.125 mol, prepared separately from sublimed CrCl₃ and THF). The resulting mixture is allowed to warm to room temperature and is then stirred overnight. The mixture is concentrated to remove about 300 mL of solvent. The green suspension is refluxed for 20 min, cooled slowly to room temperature, and then chilled overnight at −20° C. The resulting green precipitate is filtered and washed twice with Et₂O to give a green powder (˜40 g). Recrystallization from CH₂Cl₂ gives two crops, 22.5 g and 5.4 g (56% total), of the desired chromium complex 1 as dark green crystals.

### Example B

### Preparation of Chromium Complex 2

### (a) 2-Methyl-3,5,6,7-tetrahydro-s-indacen-1(2H)-one

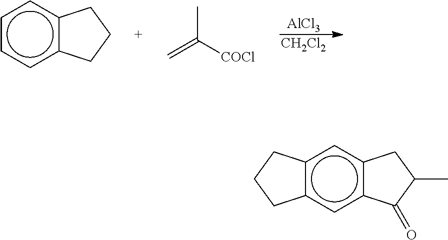

Methacryloyl chloride (50 mL, 0.5 mol) is added to a suspension of aluminium chloride (133.5 g, 1 mol) in CH₂Cl₂ (500 mL) at −78° C. and stirred for 20 min. Then indane (59 g, 0.5 mol) is added at the same temperature. The mixture warms to room temperature and is then stirred overnight. The mixture is then poured carefully into a mixture of ice (1000 g) and aqueous HCl (200 mL). The organic phase is separated, washed with water and 5% aq. NaHCO₃, and dried over MgSO₄. The solvent is evaporated and the residue is distilled under vacuum giving the desired indacenone product (77.6 g, 83%), b.p. 118-120° C./0.5 torr.

¹H NMR (CDCl₃): 7.59 (s, 1H); 7.28 (s, 1H); 3.34 (dd, 1H); 2.92 (m, 4H); 2.80-2.65 (group of signals, 2H); 2.13 (m, 2H); 1.42 (d, 3H).

¹³C NMR: 208.90, 152.82, 152.45, 143.96, 134.91, 121.85, 199.00, 42.25, 34.52, 32.90, 31.85, 25.61, 16.33.

### (b) 6-Methyl-1,2,3,5-tetrahydro-s-indacene

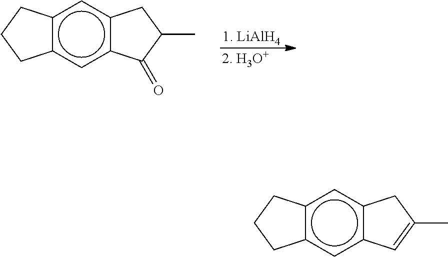

Lithium aluminum hydride (3.8 g, 0.1 mol) is carefully added to a stirred solution of 2-methyl-3,5,6,7-tetrahydro-s-indacen-1(2H)-one (37.2 g, 0.2 mol, obtained in part (a) above) in Et₂O (300 mL) under cooling (0° C.). The resulting mixture is allowed to warm to room temperature and is then stirred overnight. The resulting mixture is cooled to 0° C. and 10% aq. HCl is carefully added. The organic phase is separated and dried over MgSO₄. p-Toluenesulfonic acid (0.5 g) is then added and the reaction mixture is refluxed for 1 h. Subsequently, it is washed with aq. NaHCO₃ and saturated aq. NaCl. The organic phase is dried over MgSO₄, evaporated, and then distilled to give 6-methyl-1,2,3,5-tetrahydro-s-indacene (28.5 g, 83%). B.p. 140° C./5 torr.

¹H NMR (CDCl₃): 7.34 (s, 1H); 7.24 (s, 1H); 6.56 (s, 1H); 3.34 (s, 2H); 3.05 (m, 4H); 2.30-2.20 (group of signals, 5H).

### (c) 2-[(3-Benzyl-2-methyl-1,5,6,7-tetrahydro-s-indacen-1-yl)methyl]pyridine and 2-[(3-benzyl-2-methyl-3,5,6,7-tetrahydro-s-indacen-1-yl)methyl]pyridine

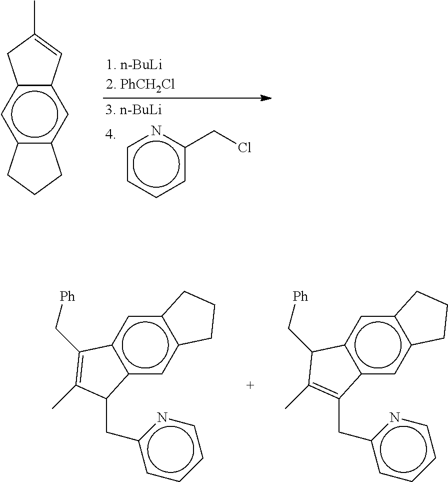

6-Methyl-1,2,3,5-tetrahydro-s-indacene (17.2 g, 0.1 mol) and Et₂O (180 mL) are cooled in a 500-mL flask to −20° C. and 2.5 M n-butyllithium in hexane (40 mL, 0.1 mol) is added over 20 min. with stirring. The mixture is allowed to warm to room temperature while stirring for 4 h. Then the mixture is cooled again (−20° C.) and is treated with a solution of benzyl chloride (11.5 mL, 0.1 mol) in Et₂O (30 mL). The mixture warms to room temperature and is stirred overnight. The mixture is then cooled to −20° C. and 2.5 M n-butyllithium in hexane (40 mL, 0.1 mol) is added over 20 min. with stirring. Cooling is removed and the reaction mixture stirs for 4 h. It is then cooled to 0° C. and treated with a solution of 2-(chloromethyl)pyridine (12.7 g, 0.1 mol) in benzene (20 mL). The resulting mixture warms to room temperature and is then stirred overnight. Water (80 mL) is added. The organic layer is isolated; the aqueous layer is extracted with Et₂O (2×40 mL). The combined organic phase is dried over MgSO₄ and evaporated. The residue is redissolved in toluene and the solution is obtained is evaporated again to give a quantitative amount of the desired indacene compound as a mixture of isomers. This product is used in the next step without purification.

### (d) Chromium Complex 2

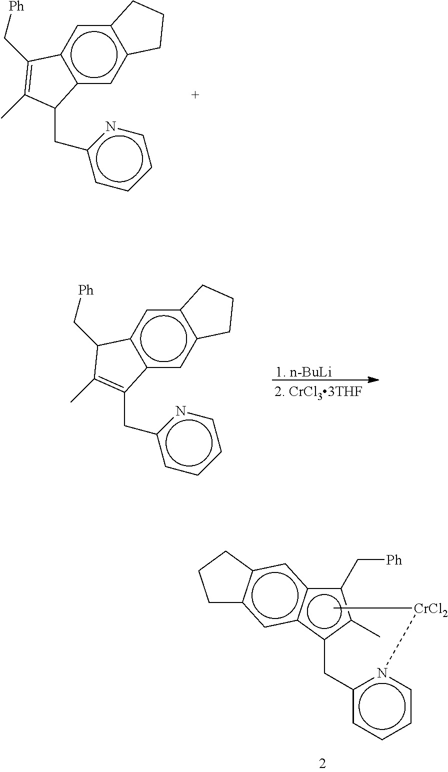

The mixture of isomers prepared in the previous step is dissolved in THF (150 mL). The solution is cooled to −70° C. and is treated with 2.5 M n-butyllithium in hexane (38 mL, 0.095 mol) over 20 min. with stirring. The mixture is stirred at the same temperature for an additional 1 h. It is then allowed to warm to room temperature and is stirred for 3 h. The mixture is cooled again to −60° C. and is treated with CrCl₃.3THF (35.5 g, 0.095 mol). The resulting mixture is allowed to warm to room temperature and is then stirred overnight. The reaction mixture is refluxed for 1 h, then cooled to −10° C. Filtration provides a green precipitate. This precipitate is washed with cold THF (50 mL), then with ether (100 mL), and then is dried to give the crude product (26.3 g, −50% from the indene). The crude chromium complex (13 g) is dissolved in CH₂Cl₂ (100 mL), and half of the solvent is evaporated. The solution is then treated with pentane (50 mL). The resulting suspension is filtered (to remove a thin white precipitate), and the filtrate is evaporated to give a green, crystalline solid. This solid is washed with CH₂Cl₂/pentane (100 mL) and dried. About 8 g of the desired chromium complex 2 is isolated. From the mother liquor, an additional 1-2 g of complex 2 can be isolated.

### Example C

### Preparation of Chromium Complex 3

The procedure of Example B, steps (c) and (d), is generally followed with minor adjustments, except that indene replaces 6-methyl-1,2,3,5-tetrahydro-s-indacene, and 1-naphthylmethyl chloride replaces benzyl chloride. For details, see U.S. Pat. Appl. Publ. No. 2008/0269445, Example 4. The resulting complex 3 provides satisfactory spectral data consistent with the structure indicated below.

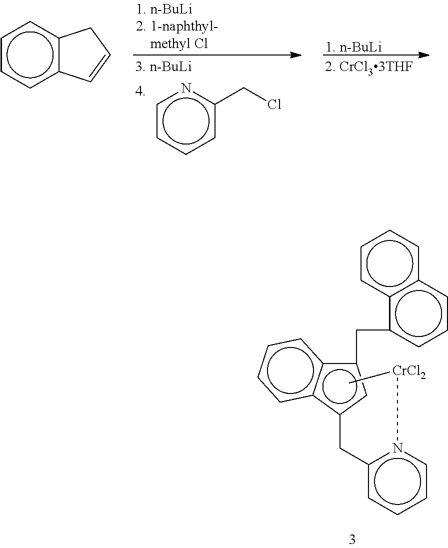

### Preparation of Silica-Supported Complexes

### Method B1

### MAO-Treated Silica (Al/Cr=100)

In a nitrogen-filled drybox, methylalumoxane (4.21 M solution in toluene, 2.2 mL, product of Albemarle) is added to a suspension of silica (Davison 948, product of GraceDavison, calcined 4 h at 250° C., 2.0 g) and dry toluene (8.0 mL), and the resulting slurry is heated at 80° C. for 2 h. Chromium complex (92 μmol) is added to the mixture, which stirs at ambient temperature for 2 h. The slurry (reddish with Cr complex 1) is filtered and washed with hexanes.

### Method B3

### MAO-Treated Silica (Al/Cr=300)

The procedure of Method B1 is repeated with 1/3 the amount of Cr complex (31 μmol).

### Method D1

### F20 Plus MAO-Treated Silica (Al/Cr=100)

The procedure of Method B1 is modified as follows. After heating the MAO-treated silica at 80° C., a mixture of the Cr complex (92 μmol) and triphenylcarbenium tetrakis(pentafluorophenyl)borate (“F20,” 186 μmol) in toluene (5 mL) is added to the MAO-treated silica at ambient temperature. The mixture stirs for 0.5 h. The slurry is then filtered as washed with hexanes as described earlier. With Cr complex 1, a greenish-tan powder results.

### Comparative Method A1

### MAO Applied by Incipient Wetness (Al/Cr=100)

In a nitrogen-filled drybox, chromium complex (92 μmol) is added as a dry powder to methylalumoxane (4.21 M solution in toluene, 2.2 mL), and the mixture stirs for 15 min. With Cr complex 1, a viscous, dark-green solution is obtained. The solution is added slowly to a stirred bed of silica (Davison 948, calcined 6 h at 600° C., 2.0 g). With Cr complex 1, the color changes from green to red and back to green.

### Comparative Method A3

### MAO Applied by Incipient Wetness (Al/Cr=300)

The procedure of Comparative Method A1 is repeated with ⅓ the amount of Cr complex (31 μmol).

### Comparative Method C

### F20 Applied by Incipient Wetness

In a nitrogen-filled drybox, a mixture of chromium complex (92 μmol) and F20 (111 μmol) in toluene (2.2 mL), which is dark red in the case of Cr complex 1, is slowly added to a stirred bed of silica (Davison 948, calcined 6 h at 600° C., 2.0 g). With Cr complex 1, the color changes from green to red and back to green.

### Ethylene Polymerization

### Examples 1-5, 11, 12, 14, and 15 & Comparative Examples 6-10, 13, and 16

A dry, 2-L stainless-steel autoclave reactor is charged with isobutane (1 L), 1-butene (100 mL), and triisobutylaluminum (1 M solution, amount shown in Table 1). The reactor is heated to 70° C. and pressurized with ethylene to 15.5 bar (225 psi) partial pressure. Silica-supported chromium catalyst (amount shown in Table 1) is flushed into the reactor with isobutane to start the polymerization. Ethylene is supplied on demand to maintain a constant reactor pressure, and the run is considered complete after 30 min. In Examples 4 and 5, hydrogen is charged to the reactor before adding the catalyst from a 300-mL vessel pressurized to 600 psi with H₂.

In most examples, ethylene consumption exhibits an initially high but declining activity during the first ten minutes of the polymerization, then a stable activity for the remainder of the run. The latter activity is reported in Table 1.

### Ethylene Polymerization

### Examples 17-21

Methods B1 and D1 are followed to make the supported catalysts, except that Silysia G-3 silica (product of Fuji) is used instead of Davison 948 silica. The G-3 silica is granular and has: diameter=3-5 μm; surface area=600 m²/g; pore volume=0.3 mL/g, and pore diameter=3 nm. (In contrast, Davison 948 silica is granular and has: diameter=50 μm; surface area=300 m²/g; pore volume=1.6 mL/g, and pore diameter=21 nm.)

Polymerizations are performed in a controlled composition unit. Thus, the reactor is equipped with a gas chromatograph that is used to analyze the vapor space composition during the run. Information from GC analysis is used to adjust the comonomer addition rate to maintain a constant concentration (within 5-10%) in the reaction mixture. Head-space concentrations of 1-butene and hydrogen are reported in Table 2.

The dry, 1.7-L stainless-steel autoclave reactor is initially charged with isobutane (395 g) and triisobutylaluminum (2.0 mM in the isobutane). The reactor is vented, then sealed and heated to 80° C. 1-Butene and ethylene are added and equilibrated at the final run conditions based on GC data. Silica-supported chromium catalyst is flushed into the reactor with isobutane to start the polymerization. Ethylene is supplied on demand to maintain a constant reactor pressure. Comonomer is fed to maintain a constant vapor phase concentration of comonomer (based on GC data). The run is considered complete after 50-60 min. The polyethylene product is recovered and analyzed, with the results shown in Table 2.

TABLE 1
Effect of Support/Activation Method

| | | Support | Supp. cat. | TIBAL | Activity | | | density |
|---|---|---|---|---|---|---|---|---|
| Ex. | Complex | Method | (mg) | (mL) | (g PE/g cat/h) | Mw | Mw/Mn | (g/cm³) |
| 1 | 1 | B1 | 88 | 2 | 607 | 1.34 × 10⁶ | 11.0 | 0.918 |
| 2 | 1 | B3 | 317 | 2 | 254 | not soluble | — | — |
| 3 | 1 | D1 | 105 | 1 | 235 | 3.31 × 10⁶ | 3.23 | — |
| 4* | 1 | D1 | 157 | 1 | 231 | 8.01 × 10⁵ | 6.09 | — |
| 5* | 1 | D1 | 105 | 3 | 136 | 2.85 × 10⁵ | 5.97 | — |
| C6 | 1 | A1 | 53 | 2 | 89 | 1.35 × 10⁶ | 6.93 | — |
| C7 | 1 | A1 | 107 | 2 | 81 | 1.32 × 10⁶ | 7.26 | — |
| C8 | 1 | A3 | 278 | 2 | 66 | 1.64 × 10⁶ | 2.92 | 0.917 |
| C9 | 1 | C | 101 | 2 | 131 | not soluble | — | — |
| C10 | 1 | C | 101 | 2** | 272 | 6.46 × 10⁵ | 7.82 | 0.935 |
| 11 | 2 | B1 | 79 | 1 | 159 | 1.44 × 10⁶ | 7.64 | 0.917 |
| 12 | 2 | B3 | 298 | 1 | 82 | 1.79 × 10⁶ | 7.63 | 0.923 |
| C13 | 2 | C | 78 | 1 | 12 | 1.42 × 10⁶ | 28.8 | — |
| 14 | 3 | B1 | 75 | 1 | 221 | 1.46 × 10⁶ | 4.6 | 0.916 |
| 15 | 3 | B3 | 235 | 1 | 75 | 1.55 × 10⁶ | 6.2 | 0.923 |
| C16 | 3 | C | 85 | 1 | 1 | — | — | — |

*All runs performed in the absence of hydrogen, except Ex. 4 (Δpsi = 20 from a 300-mL vessel initially at 600 psi H₂) and Ex. 5 (Δpsi = 100)
**Triethylaluminum used instead of triisobutylaluminum.
Method B1: MAO-treated silica, Al/Cr = 100; Method B3: same, Al/Cr = 300 Method D1: F20 + MAO-treated silica, Al/Cr = 100; Method C: F20 applied by incipient wetness Method A1: MAO applied by incipient wetness, Al/Cr = 100; Method A3: same, Al/Cr = 300

TABLE 2
Additional Runs with Fuji Silysia G-3 Silica

| | Support | C2 = | C4 = | H₂, | Activity | | | density |
|---|---|---|---|---|---|---|---|---|
| Ex. | Method | mol % | mol % | mol % | (g PE/g cat/h) | Mw | Mw/Mn | (g/cm³) |
| 17 | B1 | 46 | 1.40 | 3.5 | 138 | 3.36 × 10⁵ | 4.9 | 0.940 |
| 18 | B1 | 40 | 1.34 | 7.2 | 209 | 2.16 × 10⁵ | 4.6 | 0.940 |
| 19 | B1 | 54 | 0.77 | 11.6 | 581 | 1.74 × 10⁵ | 4.7 | 0.951 |
| 20 | D1 | 39 | 0.70 | 18.1 | 144 | 1.12 × 10⁵ | 3.5 | 0.957 |
| 21 | D1 | 47 | 0.66 | 10.9 | 215 | 2.23 × 10⁵ | 3.3 | 0.948 |
| 22 | D1 | 66 | 0.22 | 15.8 | 372 | 2.38 × 10⁵ | 3.1 | 0.947 |

All runs performed using complex 1; reaction time ~1 h
Method B1: MAO-treated silica, Al/Cr = 100; Method D1: F20 + MAO-treated silica, Al/Cr = 100.

The preceding examples are meant only as illustrations. The following claims define the invention.

We claim:

1. A method for preparing a supported catalyst, comprising combining an alumoxane-treated silica with a monocyclopentadienyl Group 6 metal complex, wherein the complex comprises a chelating Cp moiety.

2. The method of claim 1 wherein the complex is combined with a boron compound having Lewis acidity prior to its combination with the alumoxane-treated silica.

3. The method of claim 1 wherein the alumoxane is methylalumoxane.

4. The method of claim 1 wherein the Group 6 metal is chromium.

5. The method of claim 1 wherein the chelating Cp moiety is a substituted or unsubstituted cyclopentadienyl, indenyl, or fluorenyl group that is linked to an electron donor group via a divalent carbon or silicon-containing bridge.

6. The method of claim 5 wherein the electron donor group is selected from the group consisting of 2-furyl, 2-pyridyl, 2-thienyl, 2-pyrrolyl, 2-indolyl, 2-quinolinyl, and 8-quinolinyl.

7. The method of claim 5 wherein the complex has the structure: 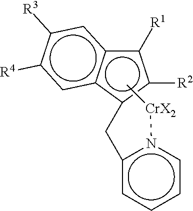
in which X is halide or C₁-C₅ alkyl, R¹ is C₇-C₂₀ aralkyl or trialkylsilyl, R² is H or C₁-C₅ alkyl, and each of R³ and R⁴ is hydrogen or are joined to form a C₅-C₆ cycloalkyl ring.

8. The method of claim 2 wherein the boron compound is an ionic borate.

9. A catalyst made by the method of claim 1.

10. A process which comprises polymerizing one or more olefins in the presence of the catalyst of claim 9.

11. The process of claim 10 wherein the olefin is selected from the group consisting of ethylene, propylene, 1-butene, 1-hexene, 1-octene, and mixtures thereof.
